(19) United States
(12) Patent Application Publication
(10) Pub. No.: US 2006/0224318 A1
(43) Pub. Date: Oct. 5, 2006

(54) Trajectory prediction

(76) Inventors: Robert C. Wilson JR., Covington, WA (US); Ted D. Whitley, Lopez Island, WA (US); Regina Estkowski, Woodland Hills, CA (US)

Correspondence Address: LEE & HAYES, PLLC, 421 W. RIVERSIDE AVE., SUITE 500, SPOKANE, WA, 99201, US

(21) Appl. No.: 11/096,251

(22) Filed: Mar. 30, 2005

(51) Int. Cl. G01C 21/00

(52) U.S. Cl. 701/213; 342/357.06

(57) ABSTRACT

Methods and systems for improved prediction of the movement of vehicles through an airspace are disclosed. In one embodiment, a method for predicting movement of a vehicle in an airspace from a first location to a second location, the predicting based upon at least one data signal configured to communicate a plurality of sensor-perceived first locations of the vehicle includes time correlating the plurality of sensor perceived first locations. The plurality of sensor-perceived first locations are particle filtered to generate a plurality of confidences each corresponding with one of a plurality of predicted locations, each confidence representing a likelihood that the corresponding predicted location includes the second location.

### FIELD OF THE INVENTION

This invention relates generally to air traffic control and, more specifically, to vehicle tracking.

### BACKGROUND OF THE INVENTION

Military and civilian control of any designated airspace relies upon accurate projection of a vehicle's movement through the space. Existing means for tracking vehicles on displays use a continuous line showing movement, but typically do not show where a vehicle is now, only where that vehicle has been in the past.

Where the vehicles are controlled through the space, a maximum number of vehicles in the space is limited by a separation radius necessary to anticipate movement needs of the several vehicles, whether that radius be determined as a function of distance with respect to each other or to hazards within the space (e.g. weather, terrain, obstructions, etc.). A magnitude of separation radius is driven by the performance characteristics of the vehicle. For instance, a looming mountain presents a much smaller hazard to a helicopter than to a glider, and therefore, the helicopter requires a smaller separation radius with respect to the mountain than does the glider.

Determining a suitable separation radius relies upon two driving components: latency (age of location knowledge) and accuracy of location relative to adjacent vehicles. Sources of data might be radar returns, transponder squawks, or voice contact with pilots in charge of the vehicle. Unfortunately, use of typical radars, especially transponder radars, may not generate location data that is accurate enough to reduce separations to a minimum possible according to vehicle performance capabilities. Additionally, typically generated points on a radar display are based upon reflected signals that indicate a vehicle's position at a time in the past (e.g. typically 6 or 8 seconds ago) based on the radar's sweep frequency. Hence, control decisions for the vehicle may be based upon information that is at least somewhat dated and which indicates where the vehicle was, not where it is.

Mitigation strategies for supplementing for deficiencies in accuracy inherent with radar have included augmenting the location data by supplementing the information with voice contact. Latency of voice contact is sometimes better but more often worse than that of radar, including concerns that the correct vehicle is being addressed (e.g. “Flight 440 turn left”). Voice contact may also afford a relatively slow feedback loop based upon the confirmation step of an air traffic controller waiting for indications on a screen to change direction. After the confirmation step, the controller may then address another instruction set to a next pilot in a next vehicle. An advantage of voice contact is that it has a predictive quality in that a pilot in charge may designate his next moves to the controller.

In addition to separation radii, emergency conditions may require all vehicles in the vicinity of a problem to “turn away”. Turn away routes are selected for each vehicle based upon the vehicle's on-board knowledge—usually not quite as good as on the ground—and may create additional problems. Even where ground-based air traffic controllers assist the pilots of vehicles, location accuracy and velocity, and latency of that knowledge are factors that drive how many vehicles can simultaneously fly in a space.

Latencies also exist in large information nets. Creating such a large information net for the purpose of managing vehicle movement will generate a measurable latency. This latency can be overcome through accurate location prediction of moving vehicles, even to the point where the latency is a system parameter specific to individual latencies in the overall net. The resultant display of vehicle location is then a real time image and enables both more dense traffic as well as significantly improving individual vehicle safety.

If the movements of vehicles through an airspace could be predicted with greater accuracy, the spacing of the vehicles in the space could be tighter, and the control of those vehicle could be done with greater accuracy, allowing more vehicles in the space. Therefore, improved methods for more accurately tracking and projecting a trajectory of a vehicle through an air space would be useful.

### SUMMARY OF THE INVENTION

The present invention is directed to methods and systems for improved prediction of the movement of vehicles through an airspace. In one embodiment, a method for predicting movement of a vehicle in an airspace from a first location to a second location includes predicting movement based upon at least one modulated data signal configured to communicate a plurality of sensor-perceived first locations of the vehicle, including time correlating the plurality of sensor-perceived first locations. The plurality of sensor-perceived first locations are particle filtered to generate a plurality of confidences each corresponding with one of a plurality of predicted locations, each confidence representing a likelihood that the corresponding predicted location includes the second location. The prediction is an effective means of overcoming latencies in a very large (e.g., Global) information net.

### BRIEF DESCRIPTION OF THIE DRAWINGS

Preferred and alternate embodiments of the present invention are described in detail below with reference to the following drawings.

FIG. 1 is a flowchart of a method for predicting a vehicle trajectory;

FIG. 2 is a block diagram of a processor for controlling aircraft in a controlled airspace; and

FIG. 3 is a isometric view of a series of probability clouds forming a trajectory.

### DETAILED DESCRIPTION

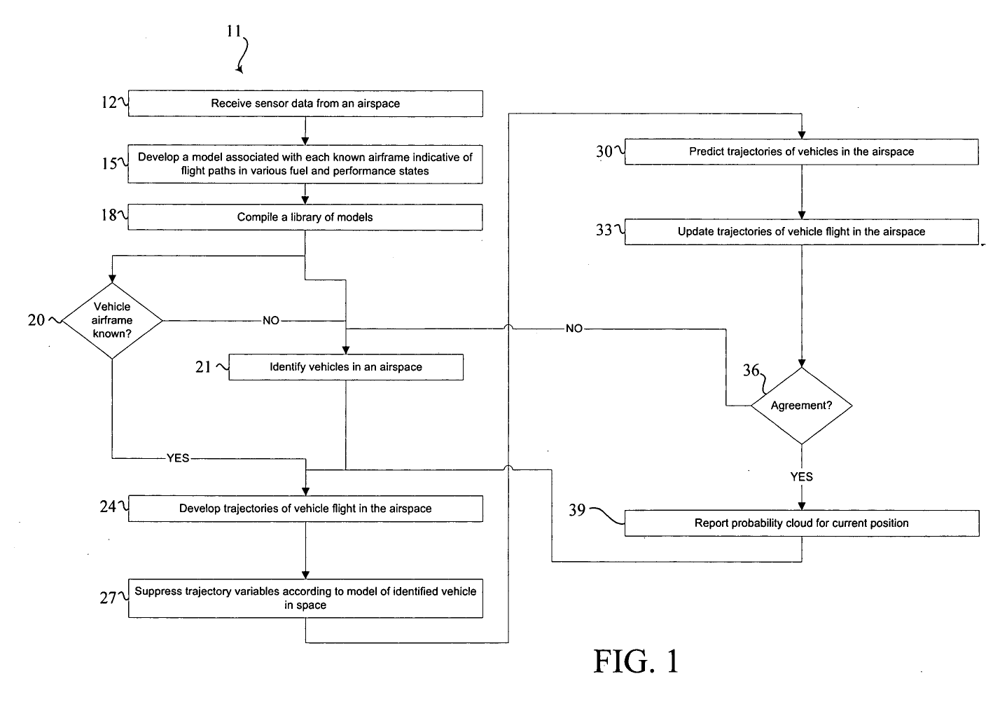

The present invention relates to generating and thus predicting trajectories of vehicles in an airspace. Many specific details of certain embodiments of the invention are set forth in the following description and in FIGS. 1, 2, and 3 to provide a thorough understanding of such embodiments. One skilled in the art, however, will understand that the present invention may have additional embodiments, or that the present invention may be practiced without several of the details described in the following description.

By way of overview, the problem of tracking a vehicle through an airspace includes processing noisy measurements received from one or more sensors over time to form tracks about potential targets. Sensors are typically very “ego-centric” in that measurements are in spherical coordinates (azimuth, elevation and range, or more likely without elevation) from returns received from the sensor over the current period. Radar return reception, in particular, is noisy in that it often includes intended target detections as well as returns from unwanted targets (e.g. from birds, clouds, the ground, and the sea surface).

In solving the tracking problem, embodiments of the present invention use sensed measurements to refine the tracks that represent a belief about a location of a tracked vehicle. Trackers sequentially update the belief track in response to an incoming stream of measurements. Bayesian algorithms, such as a Kalman filter, are selected to formulate the inference of a position for the aircraft, with a variety of algorithms used for each part of the problem.

While any of the Bayesian algorithms are suitable for practice of the invention, an embodiment of the present invention sample a number of hypothesized states (or “particles”) using a particle filter methodology. Using a particle filter adopts a different approach than has been previously accomplished by Kalman-based filters in that the particle filter does not attempt to model the distribution using an analytic form. Instead, the uncertainty (and so the distribution) is represented using the diversity of the set of particles that simply represents the distribution. Each particle is compared with the measurement and weighted accordingly. Particles with high weights are propagated and those with low weights discarded. Thus, the particle filter represents a track using a number of weighted random samples in the track space, from which it is easy to extract track estimates and measures of uncertainty.

Referring to FIG. 1, a method 11 includes receipt of sensor information from sensors detecting a vehicle presence in the airspace at a block 12. Such sensors may include, for example, not only such radars as might exist in the airspace for tracking normally collocated with a controlling facility, but also such distinct radars as may exist in the space, including those normally used for sensing weather or remote radars.

In some embodiments of the present invention, radar returns may be treated differently than is normally the case with most tracking systems. Generally, with radar returns, where there is more than one return from a vehicle, the comparison is a simple “go-no go” by comparing the returns to each other and deciding if there is sufficient agreement between the returns to accept the location the returns present as sufficiently accurate. Embodiments of the present invention, however, may treat neither of the radar returns as absolute indications, but inherently harmonizes the radar returns as discrete inputs to the particle-filtering model. As such, the model is independent of which of the several sensor types is used to locate the vehicle in the airspace but, rather, sets and then adjusts the confidence of each of the positions, in order to derive a location of high confidence.

Additionally, on board devices for navigation may also be sensors in the airspace. So long as such devices are communicative with a network, such as by means of a radio link with the vehicle in the airspace, these data are useful in placement and may augment the information discerned from the radars. The onboard systems might include onboard sensor systems such as GPS and Loran navigation, including the use of dead reckoning to decrease latency between fixes from onboard navigation sensors.

One embodiment of the invention would allow locating and tracking aircraft in an airspace based solely upon each aircraft's communication with a central processing unit. To enable the onboard systems to input into the system perceived navigation fixes, the system is configured to communicate by mean of transmission and reception of information. Each aircraft is placed in the airspace based upon the aircraft's own perception of its position in the airspace and, optionally, upon perception of the aircraft by instruments on other aircraft in the airspace, such as satellites over-flying the airplane.

To suitably enable the communication between the central processing unit and the aircraft, transmissions between the aircraft and the central processing unit, data are transmitted words setting forth the data in uniformly formatted fields. Use of uniform fields facilitates rapid input of the onboard perceptions of onboard instrumentation. The embodiment exploits flight management system-derived data constructed to include uniform fields to communicate onboard instrument perception of flight management system variables to include a timestamp and identification code to suitably identify the aircraft and the time of the navigational fix. The navigational fix optionally includes such flight management system data such as latitude, longitude, true heading relative to the ground, and ground speed. To determine a predicted position, additional information allows the particle filter to better pick out probabilities, the flight management data may optionally included altitude, pitch, roll, and yaw.

As information is received from the several sensors in the airspace and such onboard sensors from which information is received, backward study of an aircraft's movement through the airspace is possible by cataloging the data according to the timestamps that accompany the data. The data roughly indicate the movement of the aircraft through the airspace. The better the movement of the aircraft can be known as the aircraft traverses the airspace, the better probabilities for the aircraft's movement from a point in the airspace to a second point in the airspace. The goal of the backward study is to derive characteristics of an aircraft as it moves through the airspace. Collectively, the characteristics are referred to as a “performance envelope” or a “performance model.”

At a block 15, in a model development stage, models are developed for known airframes. The models are purely recorded statistics, and themselves contain no equations or formulas, as do polynomial models. The models may be built up using raw and processed data observations. Because the data received from the aircraft is identified as associated with a particular aircraft or family of aircraft, generalizations can be derived from the behavior of the aircraft within the airspace.

The data received from sensors in the airspace and onboard the aircraft is used in modeling. In particle filtering methods, the conditional probabilities and formulas for particle filtering are represented directly in the statistical models as discretized probability distributions. The model distributions are sampled in order to determine the importance weights and obtain predicted and updated particle distributions. In one embodiment of the invention, the models continue to be refined in light of additional information added in Bayesian iteration. The data received from the known aircraft is used to refine the filter and assure that optimal results result from the filter's use.

Particle filtering is a class of methods for filtering and smoothing in non-linear or non-Gaussian state space models. Particle filters are powerful sampling-based inference or learning algorithms for dynamic Bayesian networks. For instance, in a very simple single-dimensioned example, a vehicle passing along a line transits along the line a number of times under study. If the behavior of the vehicle is such that it travels at speeds between certain rates, finding a probability of a particular displacement from a first point over a period can be readily reckoned based upon the experiences of the filter.

One possible drawback of applying a particle filter process to tracking vehicles in an airspace is that sampling in high-dimensional spaces can be inefficient. In a preferred embodiment, however, the model has “tractable substructure,” which can be analytically marginalized out, conditional on certain other nodes being imputed. The advantage of this strategy is that it can drastically reduce the size of the space over which the method 11 needs to sample.

Marginalizing out some of the variables is an example of how the preferred embodiment uses the modeling mathematics of particle filtering to place the probabilities in the airspace based upon each of the several returns received. One advantage of this strategy is that it can drastically reduce the size of the space over which we need to sample. Preliminary filtering has proven very useful to marginalize out variables, the remaining issue is the judicious selection of which variables to filter out. Part of the modeling includes deciding which variables to marginalize based upon the identity of the aircraft being tracked.

In order to develop models, the central processor analyzes the data collected from aircraft transits through the airspace in order to establish a “behavior” to associate with the aircraft. The models typically include accumulations of tracks and corresponding variables such as airframe, power state, and payload that together form at least some (and possibly all) of the relevant observables relating to a vehicle's passage through the airspace. The statistical model is then used to form mathematical models. Variable states for such as power and fuel state, attitude, altitude, and heading are associated with the models as well as other suitable variables.

Development of the model includes analysis of the supplied flight management system variables that are most relevant for analysis for each identified model. For example, when tracking a Boeing™ 737, analysis of the time stamp and identification code, along with the reported latitude, longitude, and altitude have proven sufficient to allow analysis to further supply the true heading, ground speed, altitude, pitch, and roll of the aircraft under analysis. The nature of the movement of the Boeing™ 737 is predictable enough that using additional variable does not enhance a solution for establishing a position for the Boeing™ 737. For this reason, using the ground speed, altitude, pitch, and roll as independent variables in the prediction of a track solution is not useful.

Particle filtration is a process that consumes a great many computational steps. With additional variables, complexity of the solution of the particle filtration problem climbs geometrically. Suppression of additional variables is extremely important. For this reason, once an aircraft is selected for modeling, an important part of that modeling is selection of the most relevant variables, analyzing movement of a Boeing™ 737, a reported latitude, longitude, and altitude is a sufficient amount of information for particle filtration. On the other hand, because of the distinct flight characteristics of a rotary wing craft, pitch, for instance, is not helpful in predicting a track and can be dropped from analysis; similarly forward motion is not as closely related to climb rate as with fixed wing aircraft.

The exact methods and parameters used for preliminary filtering may be selected according to the input being filtered since the relative performance of the various distributions typically depends on the signal. For example, the pseudo-Wigner distribution is usually best for signals with only one frequency component at any one time, the Choi-Williams distribution is most attractive for signals in which all components have constant frequency content, and the matched filter short-time Fourier transform is usually used for signal components with significant frequency modulation. Of course, other suitable preliminary filtering methods may be used.

With continued reference to FIG. 1, in some embodiments, the initial mathematical models (block 15) are suitably developed including posterior probabilities at spaces in accord with the Markov chain representing the prior movement of the vehicle through the space. At a block 18, a library of vehicle models is compiled. The library of models is useful to identify vehicles traveling through the airspace. For each distinct track, a distinct filtering is necessary according to the aircraft being studied. Each aircraft will evoke a corresponding set of variables to minimize in order to get an optimal tracking solution. From this point, the method 11 shifts from passive observation to build models corresponding with distinct aircraft to active prediction of tracks within the airspace.

At a block 20, whether a tracked vehicle in the airspace is known determines the next step. Where a vehicle is not known, after conventional methods of interrogation, e.g. transponder squawk, radio interrogation, a preferred embodiment will identify the vehicle based upon comparison between a vehicles' trajectory through the airspace as sensed by the sensors monitoring the space with the entries in the library of models. At a block 21, the probabilities that populate each model are suitably used to identify the vehicle by any of a family of vehicles such as military fighter aircraft, or in better situations, a particular type of airframe such as an F/A 18, or in the very best situation, a particular airframe where discernable differences in performance or location are “known” to the model. By “known,” a level of statistical confidence sufficient to rule out other models is meant.

At a block 24, the trajectories of the vehicles moving in the airspace are developed from the generated models. The basic functionality of the trajectory generator is to allow the user to generate a trajectory by specifying waypoints. These waypoints provide information on various flight parameters, including, for example, latitude, longitude, altitude, and speed. In generating trajectories, the differences (between adjacent elements) for the data field values of interest are first found. The actual values are determined by summing over the differences, rather than directly. To economically develop the models for trajectory generation, the preferred embodiment exploits information relating observed differences to change over a longer period. This change is used as an approximation to actual local slope.

Because of the quantization of the data, local slope and observed differences are not the same but for a suitably selected interval, the selection of the difference is a useful surrogate for the local slope. To improve computational speed, an embodiment further exploits observed characteristics of the data to generate these models. Every latitude value, for instance, is evenly divisible by one particular rational number, which is a quantization increment.

The data differences can be clustered into a very few widely separated clusters where each cluster contains a small set of values. The values contained in these clusters are fixed for each data field, and the data differences never take on any other value. To obtain a data trajectory that is reasonable but does not contain some of the finer level detail of an actual trajectory, the presently preferred embodiment uses only the minimum and maximum values in each cluster. Often, when differences are required, to suitably discretize the outcomes, rather than using the raw data, the data used is actually the integers that result from dividing differences by the quantization increment. The data derived by these substitutions are the data that are actually clustered in the code representing the model.

Based upon the identity of the aircraft as derived at either of block 20 or 21, the set of variables to be marginalized are selected thereby allowing the suitable selection of variables for rapid discernment of a predicted flight path. The identities of the variables suitable for marginalization have been stored in association with the aircraft at the block 15 to form the model and are recalled at this time to aid in the solution of the particle filtration.

Once flight trajectory characteristics of the vehicle in the airspace is known, the trajectories of the vehicles in the airspace may be suitably predicted by means of the model at a block 30. Additionally, flight characteristics of an aircraft may be programmed into the avionics package on board for transmission of the model to a processing facility to either augment or to replace the model in the library. A predicted trajectory is a cloud in the airspace wherein the confidence that a vehicle is at each arbitrary point within the airspace exceeds a definable threshold. The cloud is defined by spatial dimensions and a time dimension such that at any one time there is a bubble that itself moves through the airspace. Given that the boundaries of each cloud are edges of likely locations of a vehicle in the airspace, the clouds can suitably pack the airspace to allow safe transit by the vehicle through the airspace.

At a block 33, in one embodiment of the invention, an updated track of the aircraft based upon additional data received from sensors at the block 12 is superimposed over the cloud representing probable positions of the aircraft. The predicted cloud representing the track of the aircraft, in most instances will suitably envelop the updated track.

At a block 36, the updated track is compared with the predicted cloud to check for the condition of enveloping the track. If the track is suitably enveloped, the prediction cloud and the track are judged to be in agreement. In the event of disagreement, the method returns to the block 21, to again identify the vehicle based upon the track information. Where there is agreement, the method moves on to the block 39 reporting a latest track prediction. The report of the prediction having issued, the process returns to the block 24.

Returning to the block 24, the trajectories of the vehicles are further developed to reflect the movement of the clouds to a “next” position, further developing the trajectories of the vehicle through the space. The blocks 24 through 39 are repeated to continually track the vehicles through the space and to further refine the probability clouds of the track.

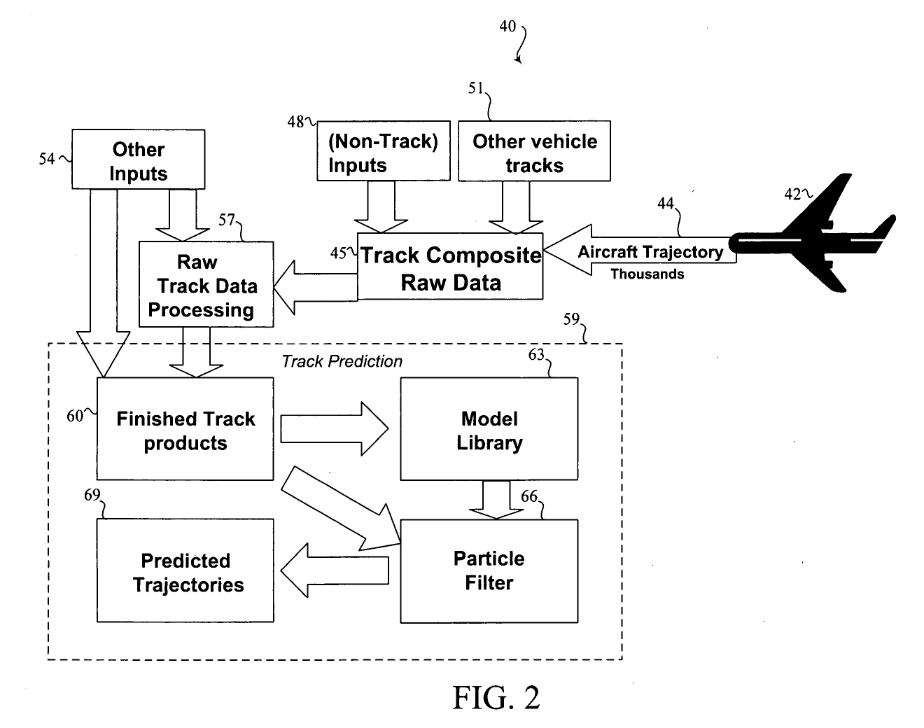

Referring to FIG. 2, a system 40 for predicting a track of an aircraft 42, through an airspace derives routes, in part, on trajectory data 44 transmitted by the aircraft 42 from its onboard avionics. Trajectory data 44 includes such information as a GPS navigational fix indicative of a position and altitude. Optional additional data includes attitude, power state, aircraft type, laden weight, fuel load and other operational data. The trajectory data is selected to well-define the performance and location state of the aircraft as it operates in the airspace, and to allow prediction of the aircraft's current course through the airspace. Trajectory data may also include some portion of a flight plan associated with the aircraft.

Trajectory data is not limited to GPS navigational information. Any of radio altimetry information, Loran fixation information, terrain-based fixation information, or any other suitable information may suitably augment the trajectory information 44 to provide more complete agreement on the navigational position, speed, heading, and altitude on the aircraft 42. All suitable on board navigational fixation means can be used for determining the position of the aircraft 42 in the airspace.

On board the aircraft 42, a data word is formulated to describe the instantaneous trajectory data 44 along with a time stamp that uniquely identifies the time the trajectory data 44 is captured. Additionally, an identifier is assigned to the aircraft 42. In some embodiments, the unique identifier is “hardwired” or permanently assigned to the aircraft 42. Alternatively, a temporary identifier is assigned as a part of a “handshake” transaction, such as when the data word is transmitted by radio to a Track Composite Raw Data Center 45. By either means, or by a hybrid process of identification, the Track Composite Raw Data Center 45 begins a track assigned to the aircraft 42.

The Track Composite Raw Data Center 45 compiles trajectory information 44 from the aircraft 42 in question, as well as trajectory information or tracks 51 from the numerous other aircraft 42 that may occupy the airspace. Additionally, non-track information 48 such as weather and terrain information augments a “big picture” view of the airspace to fully define all of the various hazards that the aircraft 42 must avoid as it transits the airspace.

Notably, the Track Composite Raw Data Center 45 is not necessarily a distinct location geographically from other assets in the system. Rather, it is a node for collecting the “big picture” information that may not, itself have all of its elements co-located at a single place in space. At some point, the trajectory data 44 from the aircraft 42 is joined with the other entire trajectory data garnered from other aircraft in the airspace and united with the weather and terrain data to give the anticipated construction of the “big picture” of the whole of the occupied airspace. As used here, man-made objects, and in the military case, threat objects such as surface-to-air missile sites, are treated as either having trajectories based upon, for example, radar tracks (as in the case of airborne objects), or alternately, as terrain data being themselves navigational limitations on the air space.

The trajectory information 44 received at the Track Composite Raw Data Center 45, and possibly augmented by at least one of weather and terrain information, is then compared to radar returns and other information held at various databases on the ground. For instance, raw tracking data 57 is the output of one or several ground tracking radar stations that give a returns based second “big picture” view of the airspace. Like the aircraft-centric views generated by compiling the trajectory data 44, the return data 57 is time stamped to give it temporal meaning when compared to the trajectory data 44.

The trajectory data 44 received from the Track Composite Raw Data Center 45 may be “hardened up” with the ground-based data 57 from the various radar tracks to ascribe to each trajectory data 44 a certainty of position. Hardening up in this context is to use more inputs for the particle filter to produce the probability clouds relating to each of the vehicles in the airspace. Thus, instead of a single point in space, each vehicle is represented in the trajectory data 44 as a cloud that within an accepted probability contains the aircraft 42. In most operational instances, the accuracy of the onboard trajectory data 44 will agree with the radar raw tracking data 57, thereby allowing very tight packing of trajectory vehicle location probability clouds.

Where there is a significant deviation in the data, ground resources can be tasked with more specific inquiry to provide better input to the particle filter; for instance, a backup radar in estimated proximity to the aircraft 42 can be directed to give a better resolution of the track of a particular aircraft. With this type of priority based redundancy, fewer radar assets are dedicated to the task of resolving each position in space. Rather, the backup radars only take on the hard cases as indicated by less workable trajectory data 44 agreement with track ground data 57. Once suitable resolution of all of the trajectory data for all of the aircraft 42 in the space is derived, the “live action big picture” of the airspace is suitably formulated.

Additionally, more data 54 are added to the “live action big picture” to give a fully workable model of the airspace. Databases in computers on the ground may be used to augment the picture with additional information, just as weather return and terrain data were possibly added to it at the Track Composite Raw Data Center 45, to give the “live action big picture” all of the data necessary to describe the occupation of the airspace. For instance, the performance characteristics of each of the aircraft 42 in the airspace may be added to the trajectory data 44 for each of the aircraft 42 to suitably predict the ability of the aircraft 42 to maneuver in the airspace. Among the several ground-based data (as used in this context, the term “ground-based” identifies data stored in a database that is relatively static compared to location data, but the invention does not require that such information be stored in a computer on the ground as opposed to in the airspace), the models stored in association with known airframes are used to further define the trajectory probability clouds in the airspace.

Recalling that the fuel state, aircraft attitude and power states, and other relevant performance data, as well as desired destination or mission data from the aircraft, were already included in the trajectory data 44 before it left the aircraft 42, the “live action big picture” includes trajectory data 44 that can be realistically used to predict probability and desirability of any aircraft 42 to reach a second location in the airspace from its current (or first) location. With such probabilities for each of the aircraft 42 within the airspace, efficient and coordinated control of the aircraft is possible.

To demonstrate the utility of knowledge of the performance and maneuvering characteristics of a particular airframe in packing an airspace, consider as an analogy the formation flying of such flight demonstration squadrons as the “Blue Angels” in the F/A-18 Hornet aircraft. Because the performance characteristics are suitably matched between the nearly identical airframes, and because of the knowledge that each of the pilots possess of the anticipated movements of each of the airframes relative to each other, the pilots are able to pack the airspace such that wingtip to wingtip separations of fewer than 36 inches are possible, thereby achieving an airspace packing efficiency that approaches the upper limit in the airspace.

Not all of the aircraft 42 in the airspace will be able or willing to make the complete disclosure of operation information comparable to trajectory data 44 received from commercial aircraft 42 on flights through the airspace. For instance, light general aviation aircraft will not have suitable avionics to transmit all of the trajectory data that would be ideal for control in the airspace. Additionally, military aircraft on missions may not be suitably able to disclose the trajectory data 44 without compromise to the security of the mission. In such instances, the Raw Track Data Processor 57 and radar tracks 51 are used to define the trajectory data 44 in the airspace. In operation, there will be a continuum of completeness of trajectory data 44 and the Raw Track Data Processor 57 will be suitably employed to augment the data to pass off a suitably precise and accurate “live action big picture” to a Track Predictor 59.

The Track Predictor 59 is assigned to each defined airspace. Airspaces may, for example, be configured to tile a defined space (e.g. the surface of the earth or some subset). For each defined airspace, the Track Predictor 59 will operate under a protocol of supervised autonomy coordinated so that there are no mid-air disasters at the boundaries of the airspace, and autonomous in that the controlling authority will route all aircraft within the airspace.

The Raw Track Data Processor 57 is configured to receive, compile, and display the “live action big picture” in the form of finished track products for Track Predictor 59. At the Track Predictor 59, the model of the trajectory is first compiled into the finished prediction at a Finished Track Compiler 60 that isolates each of the variables for processing as distinct instances for processing with the particle filter. The Finished Track Compiler 60 pulls out the identity information and suitably recalls from a Model Library 63 the flight management variables relevant according to the models stored in the Model Library 63 and the appropriate model is forwarded to a Particle Filter Processor 66 for processing finished track products from the Finished Track Compiler 60 in order to generate a predicted trajectory to a Predicted Trajectory Output 69.

The finished track or “live big picture” is both dynamic and Markov. To make the computation tractable, particle filters assume the dynamic system is Markov—that is, the current location state variable xₜ contains all relevant information. For locating objects, the Markov assumption implies that sensor measurements depend only on an object's current physical location and that in that particle filters probabilistically estimate a dynamic system's state from noisy observations. The location state could be a simple 2D position or a complex vector including 3D position, pitch, roll, yaw, and linear and rotational velocities. Particle filters represent the state at time t by random variables xₜ. At each point in time, a probability distribution over xₜ, called belief Bel(xₜ), represents the uncertainty. Particle filters aim to sequentially estimate such beliefs over the state space conditioned on all information contained in the sensor data.

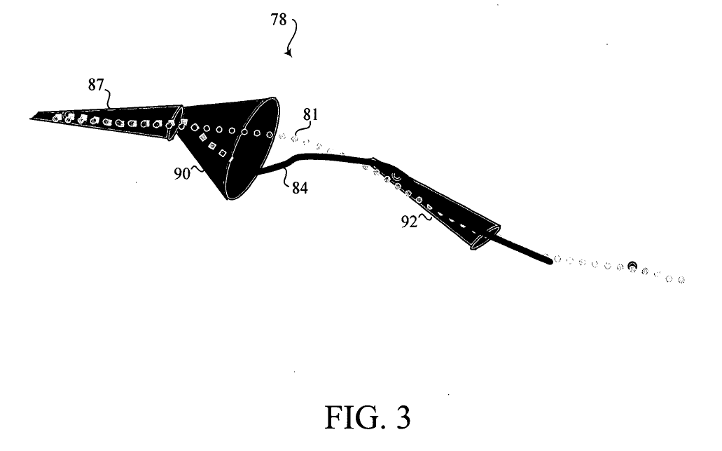

Referring to FIG. 3, a vehicle trajectory probability cloud over time 78 wherein a series of a first predicted track cloud 87, a second predicted track cloud 90, and a later track cloud 92 are shown in an illustrative conic section. In fact, probability clouds containing all positions of a specific probability or higher tend to look more like teardrops with their tails positioned at the last know point and having axes aligned generally in the direct of aircraft movement. Conic sections are illustrated to convey the overlapping relation of the first predicted track cloud 87, a second predicted track cloud 90, and a later track cloud 92. Conic sections are selected to represent the example of fixed-wing aircraft but are not suggested to limit the invention to such situation where the derived clouds are generally conic in part. The first predicted track cloud 87, a second predicted track cloud 90, and a later track cloud 92 are shown to include a curve in space, a predicted track 81, is generally configured to include centerpoints of the first predicted track cloud 87, a second predicted track cloud 90, and a later track cloud 92.

For purposes of comparison, an actual position track 84 a curve selected to include the actual positions of the aircraft that is represented by the first predicted track cloud 87, a second predicted track cloud 90, and a later track cloud 92. At a position xₜ₋₁, first predicted track cloud 87 (truncated at a leading edge here to allow a clearer illustration of the relationships of subsequent clouds) envelops the actual position track 84 based upon the location data at the position xₜ₋₁. The actual position track 84 of the vehicle through the airspace deviates from the predicted track 81. The trajectory data collected at the position xₜ, is subjected to the particle filter to yield a Bel(xₜ) the second predicted track cloud 90. The further deviation of the actual path 84 from the projected path 81 falls within the probability cloud 90 and therefore the comparison shows agreement. The method continually generates probability clouds such as the later prediction cloud 92.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A method for predicting movement of a vehicle in an airspace from a first location to a second location, comprising:
receiving at least one data signal indicative of a plurality of sensor-perceived first locations of the vehicle;
time correlating the plurality of sensor-perceived first locations of the vehicle; and
particle-filtering the plurality of sensor-perceived first locations to generate a plurality of confidences each corresponding with one of a plurality of predicted locations, each confidence representing a likelihood that the corresponding predicted location includes the second location.

2. The method of claim 1, wherein receiving at least one data signal includes receiving at least one modulated data signal indicative of a plurality of sensor-perceived first locations of the vehicle.

3. The method of claim 1, wherein at least one of the plurality of sensor-perceived first locations is derived by means of at least one of processing a radar return and processing a GPS sensor on-board the vehicle.

4. The method of claim 1, wherein at least one of the plurality of sensor-perceived first locations is derived by means of a surveillance satellite observation.

5. The method of claim 1, wherein at least one of the plurality of signals includes at least one retrieved model of the vehicle.

6. The method of claim 5, wherein the receiving at least one is receiving data signals according to the at least one retrieved model of the vehicle.

7. The method of claim 6, wherein the receiving at least one is receiving data signals according to the retrieved model of the vehicle includes excluding data signals from particle filtering based upon the at least one retrieved model of the vehicle.

8. The method of claim 5, wherein the particle filtering is based upon the at least one model of the aircraft.

9. A processor configured to predict movement of a vehicle in an airspace from a first location to a second location, comprising:
a receiving component configured to receive at least one data signal indicative of a plurality of sensor-perceived first locations of the vehicle;
a time correlating component configured to correlate the plurality of sensor-perceived first locations of the vehicle according to a time of perception; and
a particle-filtering component configured to filter the plurality of sensor-perceived first locations by particle filtering means to generate a plurality of confidences each corresponding with one of a plurality of predicted locations, each confidence representing a likelihood that the corresponding predicted location includes the second location.

10. The processor of claim 9, wherein the receiving component is configured to receive at least one modulated data signal indicative of a plurality of sensor-perceived first locations of the vehicle.

11. The processor of claim 9, wherein at least one of the plurality of sensor-perceived first locations is derived by means of at least one of processing a radar return and processing a GPS sensor on-board the vehicle.

12. The processor of claim 9, wherein at least one of the plurality of sensor-perceived first locations is derived by means of a surveillance satellite observation.

13. The processor of claim 9, wherein at least one of the plurality of signals includes at least one retrieved model of the vehicle.

14. The processor of claim 13, wherein the particle filter component includes a filter to suppress signals according to the at least one retrieved model of the vehicle.

15. The processor of claim 13, wherein the particle filter component selects signals for filtering according to the at least one received model of the vehicle.

16. The processor of claim 13, wherein the one of a plurality of signals are assigned a weighting value according to the at least one retrieved model of the vehicle.

17. A method of constructing a path for movement of a vehicle in the presence of at least one hazard in an airspace from a first location to a second location, comprising:
monitoring an airspace with sensors configured to perceive a location of the vehicle in the airspace;
generating a data signal according the location perceived by the sensors;
filtering the data signal according to a particle filter algorithm to yield a location confidence function; and
truncating the possible locations according to the location confidence function and a threshold value to yield a location cloud.

18. The method of claim 17, wherein generating a data signal includes generating a modulated data signal.

19. The method of claim 17, wherein truncating includes truncating the possible locations for a plurality of the vehicle to produce a plurality of location clouds.

20. The method of claim 17, wherein filtering the data signal includes retrieving a model corresponding to the vehicle.

21. The method of claim 20, wherein filtering the data signal is filtering according to the retrieved model.

22. The method of claim 17, wherein the filtering is particle filtering.
